(19) United States
(12) Patent Application Publication
(10) Pub. No.: US 2025/0383942 A1
(43) Pub. Date: Dec. 18, 2025

(54) ASYMMETRIC APPLICATION PROGRAMMING INTERFACE SYSTEM AND METHOD

(71) Applicants: Inventec (Pudong) Technology Corporation, Shanghai (CN); INVENTEC CORPORATION, TAIPEI CITY (TW)

(72) Inventors: Chuo-Jui WU, TAIPEI CITY (TW); Ming-Chi CHANG, TAIPEI CITY (TW); Wei-Chao CHEN, TAIPEI CITY (TW)

(21) Appl. No.: 18/984,994

(22) Filed: Dec. 17, 2024

(30) Foreign Application Priority Data
Jun. 14, 2024 (CN) 202410774902.4

(51) Int. Cl. G06F 9/54

(52) U.S. Cl. CPC G06F 9/54

(57) ABSTRACT

The present disclosure provides an asymmetric application programming interface method, which includes steps as follows. A resource transformation method for a main resource specified by a computer device of a resource provider is received; it is determined whether the resource transformation method can act on the main resource or not; when the resource transformation method can act on the main resource, based on information of the resource provider, identification code information of the main resource, and identification code information of the resource transformation method, a secret key is generated and returned to the computer device of the resource provider.

### RELATED APPLICATIONS

This application claims priority to China Application Serial Number 202410774902.4, filed Jun. 14, 2024, which is herein incorporated by reference.

### BACKGROUND

### Field of Invention

The present disclosure relates to a computer system and an operation method thereof. More particularly, the present disclosure relates to an asymmetric application programming interface system and a method thereof.

### Description of Related Art

Application programming interface (API) is one of the current mainstream methods of data transmission. Through an API, data specifications can be standardized to achieve the Internet of Things (IoT) technology for machine communication.

Among the current API styles, the RESTful API is one of the most popular styles. The RESTful API has the characteristic of assigning a unique specified uniform resource identifier (URI) or identifier to a resource (or data). Therefore, when performing operations, such as uploading (also called creating, Post), updating (Put), retrieving (Get), or deleting (Delete), etc., on the same URI (or identifier), the backend is operating on the same resource.

However, today many digital applications are frequently required to first perform resource transformation on the specified resource according to the content of operation to be performed when performing operations on resources specified by the same URI or identifier and then perform the operation, for example, the information security scenario, the artificial intelligence (AI) model scenario, and the authority scenario.

As for the information security scenario, after a data owner uploads (Post) a resource with personal information, a data demander later retrieves (Get) the resource with the personal information and will obtain a resource transformation with de-identified personal information.

As for the AI model scenario, the data owner uploads (Post) to give a raw resource used by the AI model, such as a raw picture. Later, when the data demander retrieves (Get) the resource for model training or inference, only the resource transformation of main features is needed.

As for the authority scenario, the content of a user's work is to upload (Post) all resources generated during the working process. Later, when the user wants to retrieve (Get) the same resource, he/she will obtain part of the resource permitted in accordance with the company's authority specifications.

Based on the requirements of the current RESTful API, the resources with different contents must be regarded as different resources. Therefore, for the resources that are uploaded and retrieved in the above scenarios, different specified URIs or identifiers must be established respectively. Otherwise, the resource owner must first complete the resource transformation operation before uploading. No matter with method is used, it will cause great difficulties to managing or sharing the resources or URIs (or identifiers).

In the above scenarios, each of the retrieved resources is one kind of resource transformation of the uploaded resource that matches the scenario. Hence, in reality, most of the data owners or data demanders will regard the two resources as the same resource to develop or communicate. As a result, specifying the retrieved and uploaded resources with the same URI (or identifier) will further facilitate the development or maintenance of digital application services extended by the resource.

In addition to the above-mentioned scenarios, there are scenarios where utilization frequencies of retrieving and uploading resources are an urgent need. The API service mostly plays a role of a data provider of digital applications, so the frequency of retrieving resources through the API service is usually much higher than the frequency of uploading operation. Especially, with the increase of downstream digital applications, retrieving resources will occupy more network bandwidth than uploading resources. Under the circumstance that the network bandwidth is unable to be changed, the API service must compress or simplify the uploaded resources for the continuously increasing downstream digital applications. In the above scenarios, although the content of the retrieved resources will change, they are always one kind of resource transformation of the uploaded resources. At this time, if the transformed resources are regarded as different resources and given different URIs (or identifiers), the API service will cause inconvenience to the downstream digital applications, thus reducing the willingness of the downstream developers to use.

### SUMMARY

The present disclosure provides an asymmetric application programming interface system and a method to improve the problems in the related art.

An asymmetric application programming interface method is provided. The asymmetric application programming interface method includes the following steps: receiving a resource transformation method for a main resource specified by a computer device of a resource provider; determining whether the resource transformation method can act on the main resource or not; and when the resource transformation method can act on the main resource, generating a secret key and returning the secret key to the computer device of the resource provider based on information of the resource provider, identification code information of the main resource, and identification code information of the resource transformation method.

In the foregoing, the step of determining whether the resource transformation method can act on the main resource or not includes: randomly sampling the main resource to test the resource transformation method based on a preset test ratio parameter and a preset minimum data quantity parameter; and determining that the resource transformation method can act on the main resource when the resource transformation method can act on sampled data in the main resource.

In the foregoing, the asymmetric application programming interface method further includes: receiving a request including the secret key sent by a computer device of a resource demander; decrypting the secret key to obtain the information of the resource provider, the identification code information of the main resource, and the identification code information of the resource transformation method; determining whether the information of the resource provider, the identification code information of the main resource, and the identification code information of the resource transformation method are recorded in a resource transformation storage record form or not; when the information of the resource provider, the identification code information of the main resource, and the identification code information of the resource transformation method are recorded in the resource transformation storage record form, obtaining a resource transformation from a resource storage device according to record of the resource transformation storage record form; and returning the resource transformation to the computer device of the resource demander.

In the foregoing, the asymmetric application programming interface method further includes: when the information of the resource provider, the identification code information of the main resource, and the identification code information of the resource transformation method are not recorded in the resource transformation storage record form, obtaining the main resource correspondingly and the resource transformation method correspondingly from a main resource storage record form and a resource transformation method form according to the identification code information of the main resource and the identification code information of the resource transformation method; determining whether the resource transformation method can act on the main resource or not; and after determining that the main resource can generate the resource transformation by using the resource transformation method, returning the resource transformation to the computer device of the resource demander.

In the foregoing, the asymmetric application programming interface method further includes: receiving a uniform resource identifier (URI) or an identifier and the main resource uploaded by the computer device of the resource provider; when the resource transformation method can act on the main resource, determining whether the URI or the identifier includes the identification code information of the main resource or not; and when the URI or the identifier includes the identification code information of the main resource, the main resource covering a storage resource specified by the identification code information, recording storage information and the identification code information of the main resource.

In the foregoing, the asymmetric application programming interface method further includes: when the URI or the identifier does not include the identification code information of the main resource, generating identification code information not included in a main resource storage record form and giving it to the main resource.

In the foregoing, the asymmetric application programming interface method further includes: receiving a URI or an identifier of the resource transformation method and the resource transformation method uploaded by a computer device of a resource transformation method provider; determining whether the resource transformation method can be installed in a resource transformation method carrier or not; when the resource transformation method can be installed in the resource transformation method carrier, generating the identification code information not included in a resource transformation method form and giving it to the resource transformation method; and recording the identification code information of the resource transformation method and information of the resource transformation method in the resource transformation method form.

The present disclosure provides an asymmetric application programming interface system. The asymmetric application programming interface system includes a storage device and a processor. The processor is electrically connected to the storage device. The storage device stores a main resource and a resource transformation method. The processor determines whether the resource transformation method can act on the main resource or not. When the resource transformation method can act on the main resource, the processor generates a secret key.

In the foregoing, the processor randomly samples the main resource to test the resource transformation method based on a preset test ratio parameter and a preset minimum data quantity parameter. The processor determines that the resource transformation method can act on the main resource when the resource transformation method can act on sampled data in the main resource.

In the foregoing, the asymmetric application programming interface system of further includes a transmission device. The transmission device is electrically connected to the processor. The transmission device receives a request including the secret key. The processor provides a resource transformation of the main resource generated by the resource transformation method through the transmission device.

In summary, the technical solution of the present disclosure has obvious advantages and beneficial effects as compared with the related art. By using the asymmetric application programming interface system and the asymmetric application programming interface method according to the present disclosure, the same URI (or identifier) will correspond to different resource transformations in accordance with the information of operation to be performed. After the resource owner uploads (Post) the main resource, the obtained resource, which is retrieved (Get) by the resource demander with the same URI or identifier, is the resource transformation in accordance with the resource transformation method set by the resource owner.

It is to be understood that both the foregoing general description and the following detailed description are by examples, and are intended to provide further explanation of the disclosure as claimed.

### BRIEF DESCRIPTION OF THE DRAWINGS

The accompanying drawings are included to provide a further understanding of the present disclosure, and are incorporated in and constitute a part of this specification. The drawings illustrate embodiments of the present disclosure and, together with the description, serve to explain the principles of the present disclosure.

FIG. 1 to FIG. 4 depict a flowchart of an asymmetric application programming interface method according to some embodiments of the present disclosure; and

FIG. 5 depicts a block diagram of an asymmetric application programming interface system according to some embodiments of the present disclosure.

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like parts. In other instance, well-known components and steps are not described in detail in the embodiments to avoid unnecessarily limiting the present disclosure.

One objective of the present disclosure is to establish an asymmetric API system (hereinafter referred to as the present system). The same URI (or identifier) of the present system will correspond to different resource transformations in accordance with information of operation to be performed. After a resource owner uploads (Post) a main source, the present system allows an obtained resource, which is retrieved (Get) by a resource demander with the same URI or identifier, to be a resource transformation in accordance with a resource transformation method set by the resource owner.

Through the present system, the resource owner only needs to perform the operation of uploading the main resource. The operation of resource transformation is carried out by the API system of the present disclosure.

The present system can assist (including but not limited to) the resource owner of the following scenarios to resolve the pain points that he/she often encounter.

1. Information security scenario: the resource owner can directly upload the resource with complete personal information, and no longer needs to first complete the operation of de-identification by himself/herself before uploading. At the same time, the characteristic that the resources before and after de-identification correspond to the same URI (or identifier) can allow the data owner to be free from the information security risk generated by confusing the URIs (or identifiers).

2. AI model scenario: the resource owner can perform a main feature extraction operation through the API service back end of the present disclosure. Therefore, the resource owner does not need to first transform the resource into the main feature resource by himself/herself before uploading. As a result, the resource owner only needs to perform the uploading of the main resource to the present system once, and then is able to provide a variety of different main feature resource transformations to the data demander. In addition to the convenience of sharing resources, the present system can reveal the model architecture in the form of API, which helps the interpretability of the black box of the AI model.

3. Authority scenario: after the resource provider uploads the complete resource, the present system can return part of the resource that the resource demander is allowed to obtain according to the identities and authorities of different resource demanders. When the application is similar to the present (authority) scenario, the present system is an API system that can achieve a variety of data transformations at the same time. That is, the same URI (or identifier) will return different resource transformations due to the different resource demanders.

In addition to the above functions, the present system may be an extension of the traditional RESTful API style. The traditional RESTful API style regards resources with different contents as different resources, so they must correspond to different URIs (or identifiers). In the present system, a wider definition of resource is given: “a main resource and all resource transformations of the main resource generated by a transformation method”.

As a result, in the present system all the resource transformations generated from the main resource through a specified transformation method correspond to the same URI (or identifier). As compared with the traditional RESTful, except for redefining the resource, the rest of the present system can still comply with the requirements of the RESTful API style.

The present system may include a user interface, a resource storage device, and a resource transformation method carrier.

1. User interface: it allows a user to interact with the present system, including uploading or retrieving resources and looking up a list of resource transformation methods, etc.

2. Resource storage device: a device for storing a main resource and resource transformations.

3. Resource transformation method carrier: a component that installs resource transformation methods and is responsible for performing resource transformation on the main resource.

In addition, the present system further includes a main resource storage record form, a resource transformation method form, and a resource transformation storage record form.

1. Main resource storage record form: it records an ID identification code and storage location information corresponding to the uploaded main resource.

2. Resource transformation method form: it records resource transformation method information that the users can use.

3. Resource transformation storage record form: it records an ID identification code and storage location information corresponding to the resource transformation.

In the following embodiments of the present disclosure, how the present system performs operations in response to notifications, such as uploading the main resource, uploading the resource transformation method, setting the resource transformation method, and retrieving the resource transformation, etc., sent by the user after the user knows an API service list of the present system and the present system has confirmed a user identity is explained.

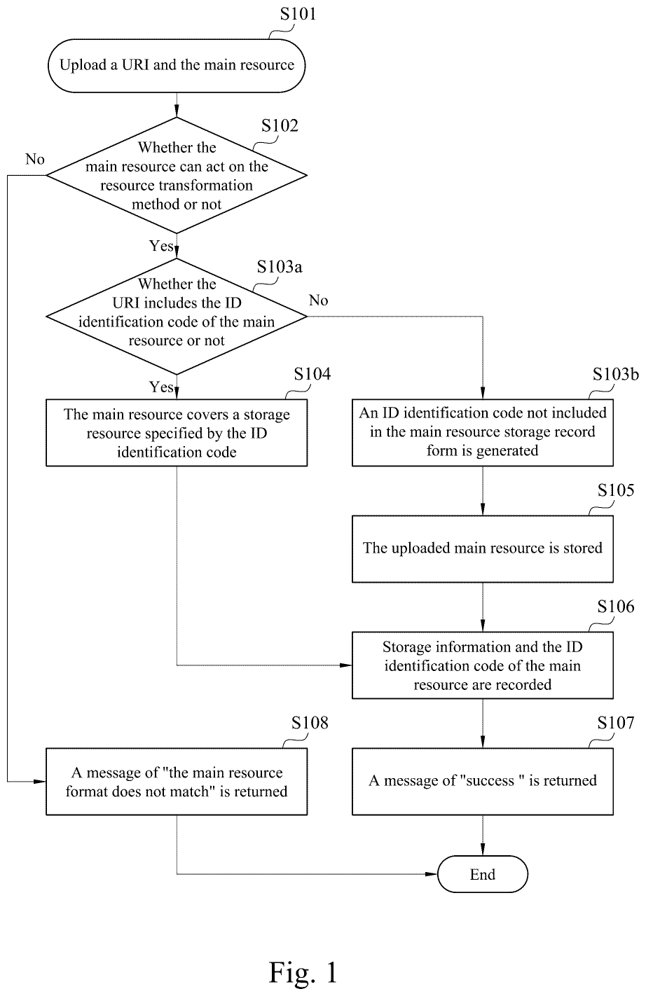

In order to further illustrate the operation method of the above system, a description is provided with reference to FIG. 1 to FIG. 4. FIG. 1 to FIG. 4 depict a flowchart of an asymmetric application programming interface method according to some embodiments of the present disclosure. It should be understood that the order of the steps described in this embodiment, unless otherwise specified, can be adjusted depending on practical needs, and the steps can even be performed simultaneously or partially performed simultaneously.

The asymmetric application programming interface method may adopt the form of a computer program product on a non-transitory computer-readable recording medium. The computer-readable recording medium has a plurality of computer-readable instructions included in the medium. The suitable recording medium may include any of the following: a non-volatile memory, such as a read only memory (ROM), a programmable read-only memory (PROM), an erasable programmable read-only memory (EPROM), an electrically-erasable programmable read-only memory (EEPROM); a volatile memory, such as a static random access memory (SRAM), a dynamic random access memory (DRAM), a double date rate random access memory (DDR-RAM); an optical storage device, such as a compact disc read-only memory (CD-ROM), a digital versatile disc read-only memory (DVD-ROM); a magnetic storage devices, such as a hard disk drive, a floppy disk drive.

As for uploading the main resource, the present system has the main resource storage record form for indicating URI (or identifier) information of each of the main resources uploaded by the resource provider. The present system will perform the operation of storing the uploaded main resource depending on whether the URI (or identifier) information of the main resource includes the ID identification code of the main resource or not when the resource provider uploads the main resource. In some embodiments, FIG. 1 depicts a detailed flow of storing the main resource uploaded by the resource provider by the present system.

In step S101, the source provider uploads a resource URI (or identifier) and the main resource. In step S102, whether the main resource uploaded in S101 can act on the set resource transformation method or not is determined. If yes, step S103a is performed. Otherwise, in step S108 a message of “the main resource format does not match” is returned.

In step S103a, whether the resource URI (or identifier) includes the ID identification code of the main resource or not is determined. If yes, step S104 is performed. Otherwise, in step S103b an ID identification code not included in the main resource storage record form is generated and step S105 is performed.

In step S104, the main resource uploaded in step S101 is used to cover a storage resource specified by the ID identification code, and step S107 is performed.

In step S105, the uploaded main resource is stored in the resource storage device.

In step S106, storage information and the ID identification code of the main resource are recorded by the present system.

In step S107, a message of “success” is returned by the present system.

In summary, as for uploading the main resource, in some embodiments of the present disclosure, in step S101 the URI or identifier and the main resource uploaded by a computer device of the resource provider is received. When it is determined that the resource transformation method can act on the main resource in step S102, whether the URI or identifier includes identification code information (such as the ID identification code) of the main resource or not is determined in step S103a. When the URI or identifier includes the identification code information of the main resource, in step S104 the main resource covers the storage resource specified by the identification code information. In step S106, the storage information and the identification code information of the main resource are recorded.

In some embodiments of the present disclosure, when the URI or identifier does not include the identification code information of the main resource, in step S103b identification code information not included in the main resource storage record form is generated and given to the main resource.

For example, the user has a storage location named “images”. The resource provider can upload the main resource through /iec100/images/ or /iec100/images/{image_id}. If the main resource is uploaded through the URI which is /iec100/images/, the present system will automatically generate an ID identification code for the uploaded main resource. If the main resource is uploaded through the URI which is /iec100/images/{image_id}, the present system will confirm whether {image_id} exists in the main resource storage record form or not. If yes, the main resource corresponding to {image_id} is covered. Otherwise, {image_id} is used as the ID identification code of the uploaded main resource.

In step S102, if the resource provider does not set the resource transformation method, it will be defaulted to “None”. Therefore, in S102 “Yes” is always returned.

Additionally, in some embodiments, when the source provider logs in for the first time, the present system will provide the resource provider with a secret key. Any user owning this secret key can upload and retrieve all the main resources of the resource provider.

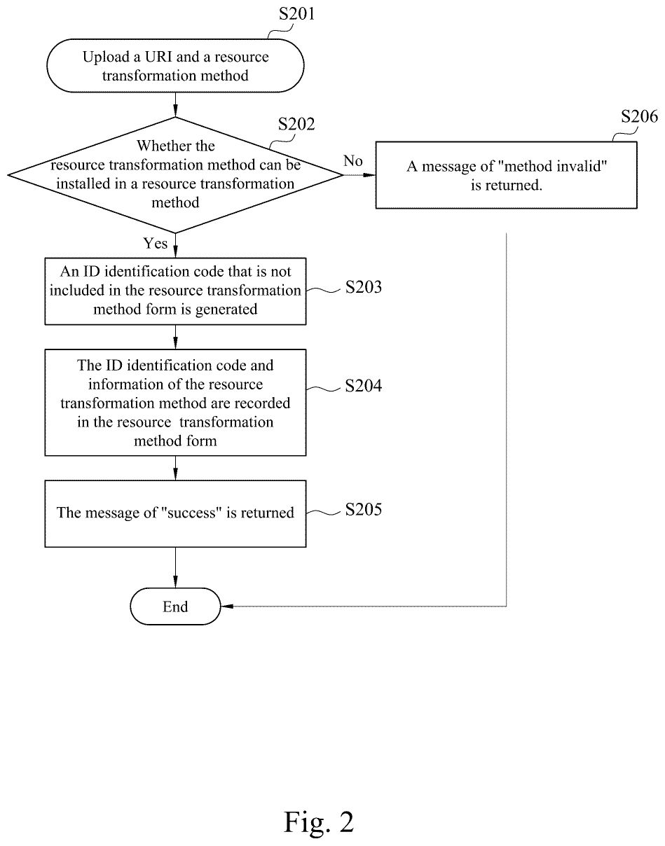

As for uploading the resource transformation method, the present system has a resource transformation method form for recording the resource transformation methods that resource providers can use. There are two types of transformation methods in the resource transformation method form: a transformation method provided by the present system itself and a transformation method uploaded by the resource provider himself/herself. In some embodiments, FIG. 2 depicts a detailed flow of storing the resource transformation method uploaded by the resource provider by the present system.

In step S201, a resource transformation method URI (or identifier) and a resource transformation method are uploaded by a resource transformation method provider.

In step S202, the resource transformation method of step S201 is installed in a resource transformation method carrier. If the installation is successful, step S203 is performed. Otherwise, a message of “method invalid” is returned.

In step S203, an ID identification code that is not included in the resource transformation method form is generated.

In step S204, the ID identification code of step S203 and information of the resource transformation method of step S201 are recorded in the resource transformation method form by the present system.

In step S205, the message of “success” is returned by the present system.

In summary, as for uploading the resource transformation method, in some embodiments of the present disclosure, in step S201 the URI or identifier of the resource transformation method and the resource transformation method uploaded by a computer device of the resource transformation method provider are received. In step S202, whether the resource transformation method can be installed in the resource transformation method carrier or not is determined. When the resource transformation method can be installed in the resource transformation method carrier, in step S203 identification code information not included in the resource transformation method form is generated and given to the resource transformation method. In step S204, the identification code information of the resource transformation method and the information of the resource transformation method are recorded in the resource transformation method form.

For example, the resource transformation method providers can upload the resource transformation method through /iec100/functions. After the present system confirms that the uploaded resource transformation method (de-identification) is successfully installed in the resource transformation method carrier, the provider can query through /iec100/functions and find that “de-identification” appears in the “customized” list. In addition to allowing the user to upload his/her own resource transformation method, the present system also provides the built-in resource transformation method. For example, the built-in resource transformation methods of the present system are all placed in the “common” list.

In step S202, there are many ways to install the resource transformation method in the resource transformation method carrier. For example, the present system is built and runs in a programming environment, such as R language or Python, and confirms whether or not the transformation method can be run in the programming environment correspondingly. Alternatively, a containerization tool, such as Docker, etc., is used to containerize the uploaded resource transformation method, etc. Regardless of which method is used for installation, the present system can manage and operate the resource transformation methods through the resource transformation method form.

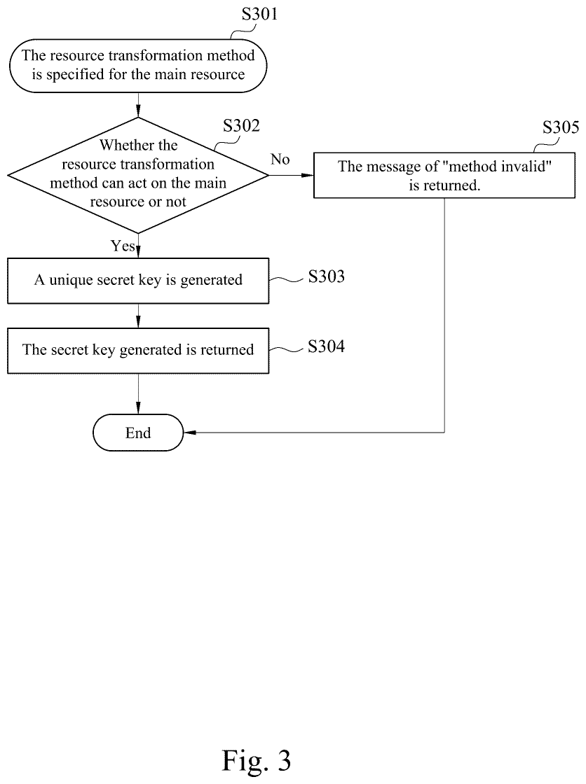

As for setting the resource transformation method, the present system provides the resource provider with a default URI (or identifier) for specifying the resource transformation method included in the resource transformation method carrier. After the present system confirms that the specified resource transformation method can perform a resource transformation operation on the main resource, the present system will return a secret secret key to the resource provider as a basis for the data demander to retrieve the resource transformation. In some embodiments, FIG. 3 depicts detailed flow of operations of the present system when the resource provider sets the resource transformation method.

In step S301, the ID identification code of the resource transformation method is specified for the main resource by using a default URI (or identifier) by the resource provider.

In step S302, whether the resource transformation method of step S301 can act on the main resource or not is tested by the present system. If yes, step S301 is performed. Otherwise, the message of “method invalid” is returned.

In step S303, a unique secret key is generated by the present system based on the resource provider, the ID identification code of the main resource, and the ID identification code of the resource transformation method.

In step S304, the secret key generated in step S303 is returned.

In summary, as for setting the resource transformation method, in some embodiments of the present disclosure, in step S301 the resource transformation method specified for the main resource by the computer device of the resource provider is received. In step S302, whether the resource transformation method can act on the main resource or not is determined. When the resource transformation method can act on the main resource, in steps S303, S304 the secret key is generated and returned to the computer device of the resource provider based on information of the resource provider, the identification code information (such as the ID identification code) of the main resource, and the identification code information (such as the ID identification code) of the resource transformation method.

For example, the present system allows the resource provider to specify a series of resource transformation methods for the main resource in step S301. When step S301 is to specify the series of resource transformation methods, the present system will test the main resource in step S302 according to the order of the series of resource transformation methods specified by the resource provider. If during the test process, there is one resource transformation method that can not work, then the message of “Method invalid” is returned. For example, the resource provider can set the resource transformation methods for all the main resource in the storage location named “images” through a URI which is /iec100/images/set_functions.

For example, the resource transformation methods set for all the main resource in the storage location “images” by the resource provider are a series of source transformation methods [ai_cnn, ai_softmax]. After the present system tests and finds that [ai_cnn, ai_softmax] can successfully act on “Images”, a secret key (function_key) that is c9c294ba-6bc2-4a1c-a322-cd043336249c is returned.

In some embodiments, one storage location often includes a lot of main resource. Therefore, in step S302 testing whether the resource transformation method can act on all the main resource included in the storage location or not can be very time-consuming. In consideration of this, the present system has a built-in preset test ratio parameter and a preset minimum data quantity parameter as a basis for random sampling test of the main resource. Additionally, a number of sampled data quantity is calculated and obtained by the following formula: max (test ratio parameter×number of main resource data quantity, min (number of main resource data quantity, minimum data quantity parameter)).

For example, the test ratio parameter is set to 80% and the minimum data quantity parameter is 200, so it indicates that the number of data quantity max (80%×number of main resource data quantity, min (number of main resource data quantity, 200)) is randomly drawn from the main resource by the present system to test the resource transformation method. When the number of main resource data quantity is more than 200, the present system will draw the number of data quantity max (80%×number of main resource data quantity, 200) to perform testing. As a result, it is ensured that the number of data quantity drawn is at least not less than 200. When the number of main resource data quantity is less than 200, the present system will test all data of the main resource. If all the data are tested, the present system only needs to set the test ratio parameter to 100%. Obtaining the “yes” response in step S302 means that the number of data quantity randomly drawn from the main resource can all be successfully executed.

In summary, as for step S302, in some embodiments of the present disclosure, the main resource is randomly sampled to test the resource transformation method based on the preset test ratio parameter and the preset minimum data quantity parameter. When the resource transformation method can act on the sampled data in the main resource, step S302 determines that the resource transformation method can act on the main resource.

In addition to that, as for generating the unique secret key in step S303, since information for generating the secret key by the present system includes the resource transformation method, the present system allows the resource provider to specify different resource transformation methods for a same main resource (different secret keys are therefore generated). Hence, when the resource provider needs to provide the data demander to retrieve a variety of different resource transformations, they only need to be performed through different secret keys (if the resource provider intends to provide the main resource without any transformation, the resource transformation method can be defined as a default value “None”, and the present system will also generate a secret key correspondingly). Some current generative technologies are available for implementation, such as RSA, DSA, ECDSA, TLS, or SSH, etc. Any technology that can generate a unique secret key is the technology that the present system can use.

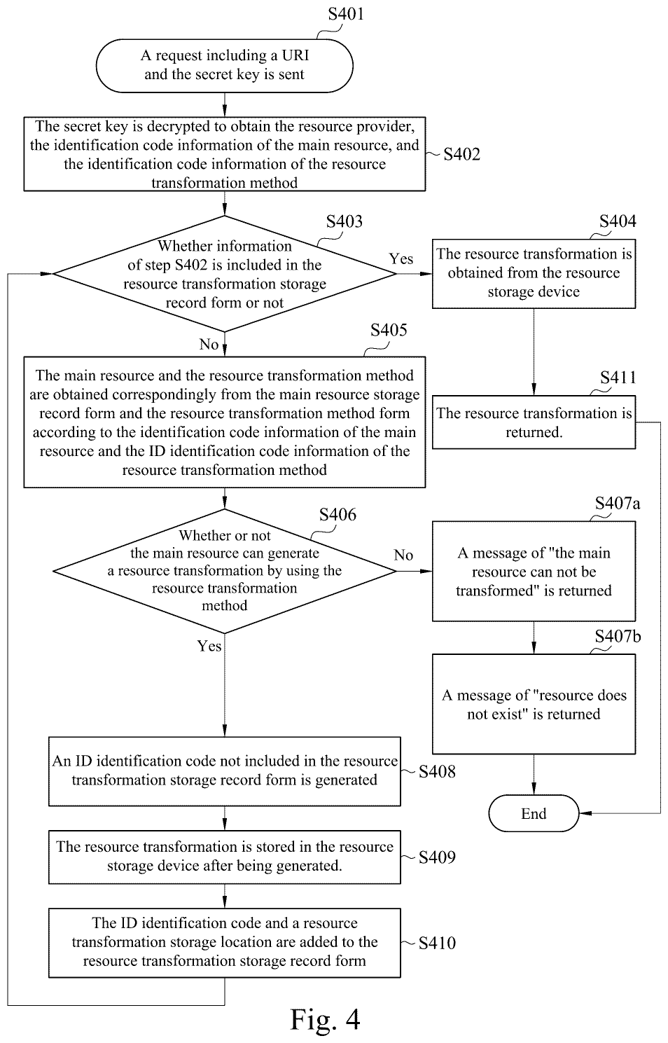

As for retrieving the resource transformation, when the resource provider obtains the secret key returned by the present system in setting the resource transformation method depicted in FIG. 3, any resource demander who gets the secret key can use secret key information to obtain the resource transformation intended to be provided by the resource provider from the present system. In some embodiments, FIG. 4 depicts a detailed flow of the present system to provide a data demander who gets the secret key to retrieve the resource transformation.

In step S401, a request including a URI (or identifier) and the secret key is sent by the resource demander.

In step S402, the secret key of step S401 is decrypted to obtain the resource provider, the identification code information of the main resource, and the identification code information of the resource transformation method.

In step S403, it is determined whether information of step S402 is included in the resource transformation storage record form or not. If yes, step S404 is performed. Otherwise, step S405 is performed.

In step S404, the resource transformation is obtained from the resource storage device according to information of the resource transformation storage record form of step S403.

In step S405, the main resource and the resource transformation method are obtained correspondingly from the main resource storage record form and the resource transformation method form according to the identification code information of the main resource and the identification code information of the resource transformation method of step S402.

In step S406, it is determined whether or not the main resource of step S405 can generate a resource transformation by using the resource transformation method of step S405. If no, step S407 is performed. Otherwise, step S408 is performed.

In step S407a, a message of “the main resource can not be transformed” is returned to the resource provider. In step S407b, a message of “resource does not exist” is returned to the resource demander.

In step S408, an ID identification code not included in the resource transformation storage record form is generated.

In step S409, the resource transformation is stored in the resource storage device after being generated.

In step S410, the ID identification code of step S408 and a resource transformation storage location of step S409 are added to the resource transformation storage record form, and return to step S404.

In step S411, the resource transformation is returned.

In summary, as for retrieving the resource transformation, in some embodiments of the present disclosure, in step S401 the request including the secret key sent by a computer device of the resource demander is received. In step S402, the secret key is decrypted to obtain the information of the resource provider, the identification code information of the main resource, and the dentification code information of the resource transformation method. In step S403, it is determined whether the information of the resource provider, the identification code information of the main resource, and the identification code information of the resource transformation method are recorded in the resource transformation storage record form or not. When the information of the resource provider, the identification code information of the main resource, and the identification code information of the resource transformation method are recorded in the resource transformation storage record form, in step S404 the resource transformation is obtained from the resource storage device according to record of the resource transformation storage record form. In step S411, the resource transformation is returned to the computer device of the resource demander.

In addition, in some embodiments of the present disclosure, when the information of the resource provider, the identification code information of the main resource, and the identification code information of the resource transformation method are not recorded in the resource transformation storage record form, in step S405 the corresponding main resource and resource transformation method are obtained from the main resource storage record form and the resource transformation method form according to the identification code information of the main resource and the identification code information of the resource transformation method. In step S406, it is determined whether the resource transformation method can act on the main resource or not. After determining that the main resource can generate the resource transformation by using the resource transformation method, the resource transformation is returned to the computer device of the resource demander in step S411.

For example, after the secret key (function_key) is generated, the resource provider can share the generated secret key with the resource demander. When the resource demander obtains the resource through the URI which is /iec100/images/{image_id} by using the generated secret key, it will not be the main resource but a transformation of the main resource.

In some embodiments, the present system will first confirm whether the resource transformation requested by the data demander has been generated of not. If not, the present system will first generate the requested resource transformation and store it in the resource storage device. Afterwards, the resource transformation is obtained from the resource storage device and returned to the data demander. Therefore, the present system will consume more time to retrieve the resource transformation for the first request. If it is expected that the resource demander does not have the time-consuming problem even for the first request, the present system can be adjusted to add an operation of performing resource transformation on all the main resources and store them in a resource storage system when setting the resource transformation method in FIG. 3. However, this design method will require the maximum space of a resource storage system. If it is expected to complete the operation of the resource demander to retrieve the resource transformation by using a resource storage device with the minimum space, only resource transformation related operations are performed and operations related to storing in the resource storage device are not performed when the resource demander sends a retrieve request. At this time, the present system does not need a resource transformation storage record form. However, this will cause the resource demander to spend the most time each time the retrieve request for the same resource transformation is sent.

Or, as for step S406, since the present system currently uses a random sampling method to confirm when setting the resource transformation method in FIG. 3, some data of the main resource may still be unable to be recourse transformed. Step S406 is a prevention mechanism for the resource that can not be resource transformed. If the test ratio parameter is set to 100% in setting the resource transformation method of FIG. 3, then step S406, and steps S407a, S407b, etc. can all be omitted. Even more, the flow of setting the resource transformation method in FIG. 3 can be added with the operation of “outputting resource transformation and storing it in the resource storage device”, that is, steps S406 to S410 are included in step S302 of setting the resource transformation method in FIG. 3.

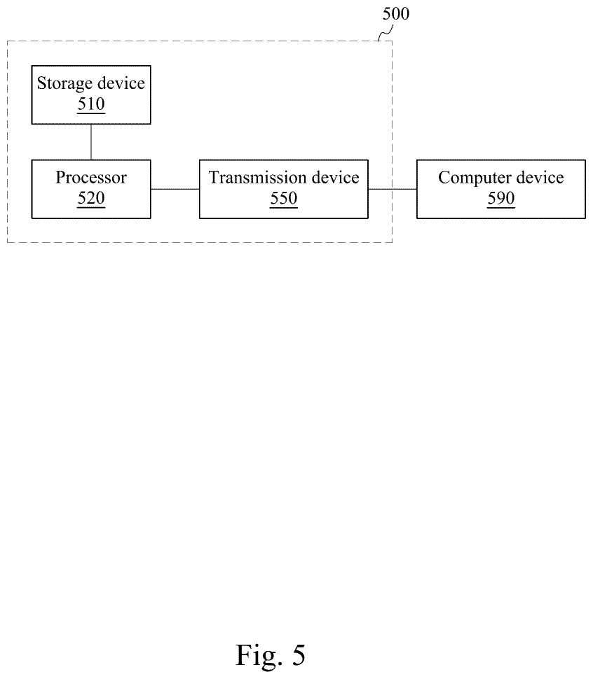

FIG. 5 depicts a block diagram of an asymmetric application programming interface system 500 according to some embodiments of the present disclosure. As shown in FIG. 1, the asymmetric application programming interface system 500 includes a storage device 510, a processor 520, and a transmission device 550. For example, the storage device 510 may be a hard disk, a flash memory, or some other storage medium. The processor 520 may be a central processing unit, a controller, or some other circuit. The transmission device 550 may be a transmission interface, a transmission line, a network device, a communication device, or some other transmission medium.

As for structure, the storage device 510 is electrically connected to the processor 520. The processor 520 is electrically connected to the transmission device 550. Data transmission can be performed between the transmission device 550 and a computer device 590.

In practice, for example, the computer device 590 may generally refer to the above computer device of the resource provided and/or the above computer device of the resource demander. The storage device 510 may be used as the above resource storage device and resource transformation method carrier. The storage device 510 may store the above main resource storage record form, resource transformation method form, and resource transformation storage record form. The processor 520 can provide the above user interface to the computer device 590 through the transmission device 550.

In some embodiments of the present disclosure, the storage device 510 stores a main resource and a resource transformation method. The processor 520 determines whether the resource transformation method can act on the main resource or not. When the resource transformation method can act on the main resource, the processor 520 generates a secret key.

In some embodiments of the present disclosure, the processor 520 randomly samples the main resource to test the resource transformation method based on a preset test ratio parameter and a preset minimum data quantity parameter. When the resource transformation method can act on sampled data in the main resource, the processor 520 determines that the resource transformation method can act on the main resource.

In some embodiments of the present disclosure, the transmission device 550 receives a request including the secret key. The processor 520 provides a resource transformation of the main resource generated by the resource transformation method through the transmission device 550.

In summary, the technical solution of the present disclosure has obvious advantages and beneficial effects as compared with the related art. By using the asymmetric application programming interface system 500 and the asymmetric application programming interface method according to the present disclosure, the same URI (or identifier) will correspond to different resource transformations in accordance with the information of operation to be performed. After the resource owner uploads (Post) the main resource, the obtained resource, which is retrieved (Get) by the resource demander with the same URI or identifier, is the resource transformation in accordance with the resource transformation method set by the resource owner.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims and their equivalents.

What is claimed is:

1. An asymmetric application programming interface method comprising the following steps:
receiving a resource transformation method for a main resource specified by a computer device of a resource provider;
determining whether the resource transformation method can act on the main resource or not; and
when the resource transformation method can act on the main resource, generating a secret key and returning the secret key to the computer device of the resource provider based on information of the resource provider, identification code information of the main resource, and identification code information of the resource transformation method.

2. The asymmetric application programming interface method of claim 1, wherein the step of determining whether the resource transformation method can act on the main resource or not comprises:
randomly sampling the main resource to test the resource transformation method based on a preset test ratio parameter and a preset minimum data quantity parameter; and
determining that the resource transformation method can act on the main resource when the resource transformation method can act on sampled data in the main resource.

3. The asymmetric application programming interface method of claim 2, further comprising:
receiving a request comprising the secret key sent by a computer device of a resource demander;
decrypting the secret key to obtain the information of the resource provider, the identification code information of the main resource, and the identification code information of the resource transformation method;
determining whether the information of the resource provider, the identification code information of the main resource, and the identification code information of the resource transformation method are recorded in a resource transformation storage record form or not;
when the information of the resource provider, the identification code information of the main resource, and the identification code information of the resource transformation method are recorded in the resource transformation storage record form, obtaining a resource transformation from a resource storage device according to record of the resource transformation storage record form; and
returning the resource transformation to the computer device of the resource demander.

4. The asymmetric application programming interface method of claim 3, further comprising:
when the information of the resource provider, the identification code information of the main resource, and the identification code information of the resource transformation method are not recorded in the resource transformation storage record form, obtaining the main resource correspondingly and the resource transformation method correspondingly from a main resource storage record form and a resource transformation method form according to the identification code information of the main resource and the identification code information of the resource transformation method;
determining whether the resource transformation method can act on the main resource or not; and
after determining that the main resource can generate the resource transformation by using the resource transformation method, returning the resource transformation to the computer device of the resource demander.

5. The asymmetric application programming interface method of claim 1, further comprising:
receiving a uniform resource identifier (URI) or an identifier and the main resource uploaded by the computer device of the resource provider;
when the resource transformation method can act on the main resource, determining whether the URI or the identifier comprises the identification code information of the main resource or not; and
when the URI or the identifier comprises the identification code information of the main resource, the main resource covering a storage resource specified by the identification code information, recording storage information and the identification code information of the main resource.

6. The asymmetric application programming interface method of claim 5, further comprising:
when the URI or the identifier does not comprise the identification code information of the main resource, generating identification code information not comprised in a main resource storage record form and giving it to the main resource.

7. The asymmetric application programming interface method of claim 1, further comprising:
receiving a URI or an identifier of the resource transformation method and the resource transformation method uploaded by a computer device of a resource transformation method provider;
determining whether the resource transformation method can be installed in a resource transformation method carrier or not;
when the resource transformation method can be installed in the resource transformation method carrier, generating the identification code information not comprised in a resource transformation method form and giving it to the resource transformation method; and
recording the identification code information of the resource transformation method and information of the resource transformation method in the resource transformation method form.

8. An asymmetric application programming interface system comprising:
a storage device storing a main resource and a resource transformation method; and
a processor electrically connected to the storage device, the processor determining whether the resource transformation method can act on the main resource or not, when the resource transformation method can act on the main resource, the processor generating a secret key.

9. The asymmetric application programming interface system of claim 8, wherein the processor randomly samples the main resource to test the resource transformation method based on a preset test ratio parameter and a preset minimum data quantity parameter, the processor determines that the resource transformation method can act on the main resource when the resource transformation method can act on sampled data in the main resource.

10. The asymmetric application programming interface system of claim 8, further comprising
a transmission device electrically connected to the processor, the transmission device receiving a request comprising the secret key, the processor providing a resource transformation of the main resource generated by the resource transformation method through the transmission device.
